(19) United States
(12) Patent Application Publication
(10) Pub. No.: US 2011/0258006 A1
(43) Pub. Date: Oct. 20, 2011

(54) SYSTEM AND METHOD FOR ANCILLARY OPTION MANAGEMENT

(76) Inventors: Michael Thomas Koetting, Orono, MN (US); Thomas Anthony Depasquale, Arlington, VA (US); Michael Fredericks, Farifax, VA (US)

(21) Appl. No.: 12/901,947

(22) Filed: Oct. 11, 2010

Related U.S. Application Data
(60) Provisional application No. 61/324,533, filed on Apr. 15, 2010.

(51) Int. Cl. G06Q 10/00

(52) U.S. Cl. 705/5

(57) ABSTRACT

A computer-implemented method and/or system of ancillary travel option management comprising: receiving, by at least one booking and/or expense management application, travel request data for at least one traveler; retrieving, by the at least one booking and/or expense management application, at least one primary travel product and/or service option, each at least one primary travel product and/or service option from at least two providers meeting at least some of the criteria of the travel request data; determining, by the at least one booking and/or expense management application, at least one ancillary option and at least one price for the at least one ancillary option related to the at least one primary travel product and/or service; and presenting the at least one ancillary option and the at least one price for the at least one ancillary option with the at least one primary travel product and/or service option.

### CROSS-REFERENCED TO RELATED APPLICATIONS

This application is based on and derives the benefit of the filing date of U.S. Provisional Patent Application No. 61/324,533, entitled “A System and Method for Ancillary Travel Vendor Fee Expense Management” filed Apr. 15, 2010. Furthermore, this application incorporates by reference U.S. patent application Ser. No. 12/773,282, entitled “System and Method for Ancillary Travel Vendor Fee Expense Management”, filed on May 4, 2010. In addition, this application incorporates by reference U.S. patent application Ser. No. 10/373,096 (now U.S. Pat. No. 7,720,702), entitled “System and Method for Integrating Travel and Expense Management”, filed on Feb. 26, 2003. The entirety of all of these applications are herein incorporated by reference.

### BRIEF DESCRIPTION OF THE FIGURES

FIG. 1 illustrates the primary components of a representative operating environment, according to an embodiment of the present invention.

FIG. 2 is a system diagram illustrating a booking and/or expense management application, according to one embodiment of the present invention.

FIGS. 3-4 is are flowcharts illustrating methods for ancillary option and fee management, according to embodiments of the present invention.

FIGS. 5-7 are screen shots illustrating example scenarios experienced by a user, according to embodiments of the present invention.

### DESCRIPTION OF EMBODIMENTS OF THE INVENTION

Many entities (e.g., companies, governments, charities) compete on cost. These entities can increase their revenue by allowing customers to purchase additional goods or services at or before the time of consuming at least one primary good or service offered. In addition, entities may offer ancillary products or services for free in order to entice customers to do business with them. Furthermore, entities can even offer a discount to entice customers to do certain things (e.g., $400 for giving up a seat on an overbooked plane; $10 dollars off for volunteering to sit at the back of the plane). Thus, in the discussion below, although “ancillary options and “ancillary fees” are described, it should be noted that the ancillary option can provide an option to obtain an ancillary product or service, or just be providing information (e.g., on a travelers frequent flier status); and an ancillary fee can actually be a positive amount (e.g., $10), 0 (e.g., for a frequent flyer, or to give a certain entity a better reputation for customer service), or a negative amount (e.g., refund of $10 from an airline). It should also be noted that the example of an airline is discussed in this specification. However, those of ordinary skill in the art will see that the concepts could be applied to other entities, both within the larger travel industry (e.g., air travel, hotel, rental car, rail) and across other industries.

For example, airlines have a business with extremely large fixed costs (e.g., aircraft costs, labor costs) and relatively small variable costs (e.g., fuel costs, drink costs). Airlines often compete on price. Airlines can add ancillary options above and beyond the primary service offered, which is the basic ticket. These ancillary options can include, but are not limited to: advanced reserved seating, preferential seating (e.g., seats with more leg room, exit row seats, or aisle/window seats), frequent flier miles, blankets and pillows, on-board concessions (e.g., food and beverage), in-flight internet access, checking bags, carrying on bags and storing them in the overhead compartments above the seats, and even using the lavatories. Those of ordinary skill in the art will see that many other types of ancillary options can be offered.

From a marketing standpoint, the airlines can also find ancillary fees attractive because the concept allows each passenger to determine the specific service level desired. If a traveler wishes to save money, the traveler could choose not to earn frequent flier miles, sit in a middle seat, not check a bag, and choose not to avail herself of the on-board dining options. A traveler who wished to travel in more comfort could elect to pay for all of these things. The two travelers may pay widely different rates for seats next to each other on the same plane, and both may be happy with the value received per dollar spent.

Furthermore, airlines can determine that highly valued customers (e.g., frequent flyers) can receive many ancillary options for free, whereas other customers would be required to pay for these ancillary options, or pay a higher price for such ancillary options. In this way, the airlines can entice highly valued customers to travel with them.

It should be noted that markets can change frequently. Airlines and other vendors can change ancillary fees quite frequently, which can make it difficult to track the costs of ancillary fees. Ancillary fees can pose additional challenges to entities managing their costs. These challenges are described in more detail below.

Many times, expenses incurred by the traveler while traveling at the request of his employer are reimbursed by the corporation. Companies have travelers (or other users, such as assistants, accountants, etc.) complete expense reports that itemize the expenses, and have the expense reports approved by managers and/or employees in the accounting department. Systems that automate some or all of the expense reporting process can accept data feeds from corporate credit card vendors (e.g. Visa, American Express, MasterCard) and can allow the travelers to import the credit card charges to reduce manual data entry and improve accuracy. Expense management systems can also be integrated with travel agency systems, global distribution systems (GDS) (e.g., Apollo, Sabre, or Amadeus) or direct connections to travel vendor reservation systems, or any combination thereof, to obtain, for example, travel itinerary data. The travel itinerary data can be matched with credit card data (using, for example, vendor information, amounts, dates of travel, etc.). Companies can then run reports on their travel and expense data to look at the total spent by type of transaction (e.g. air fare, rental car, meals, entertainment) or the total spent by supplier (e.g. United Airlines vs. American Airlines). More sophisticated systems can compare the amounts requested for reimbursement against the amount of a reservation to see if the actual cost differed from the initially requested cost, analyze the vendor spend for specific geographic regions or airline city pairs, and import receipts directly from vendors in order to have a third source for matching against the travel itinerary and credit card data.

Travel managers can use the reservation and expense data when negotiating with airlines. For example, if a travel manager knows that her company is spending $1 million per year flying travelers from Washington, D.C. to Los Angeles, Calif., and that the amount is evenly split between two competing airlines, that travel manager could approach the airlines and offer to shift business from one to the other in exchange for some form of discount. Additionally, travel managers can set policies in systems that enable travelers to make travel reservations and systems that automate the completion of expense reports to indicate that certain expenses would not be reimbursed, or would need extra approval prior to reimbursement. For example, many companies do not reimburse for movies rented during hotel stays, or for airline club memberships (e.g. United Airlines Red Carpet Club) except under certain circumstances such as trips over a certain number of days or trips over a certain distance, or for certain very frequent travelers.

In the above situations, as well as in many other situations, ancillary options and fees can pose a challenge. For example, some ancillary fees can be charged at the time of the main purchase (e.g., at the time a ticket is purchased), while other ancillary fees are charged a check-in process or on-board. A traveler may not know at time of ticket purchase that a bag would be checked, or that the traveler would want a pillow on board. These ancillary fees can thus be charged to the traveler (e.g., via credit card) at a different time than the airline ticket itself. Thus, an entity would not always know what is being spent on these ancillary fees as opposed to the air fares themselves.

In addition, ancillary fees can pose challenges for travel agencies (also called travel management companies). The ancillary options can easily be purchased through airlines websites, kiosks, or on the plane. However, the ancillary options sometimes cannot be easily purchased through a GDS that a travel agency could use to make a travel reservation. While some GDSs are trying to add support for purchase of the ancillary options, each provider may have to make an additional investment to support each GUS, so it is difficult to have each provider sell each ancillary option through each GDS. If a GDS is able to offer ancillary services and/or products for a given provider, that GDS may charge a fee or collect a portion of the revenue. If there is a lack of ability to sell the ancillary fee, the travel agency may risk losing users who prefer to purchase these ancillary options at the time of booking the primary service and/or product.

Additionally, entities have an interest in knowing where all their company's travelers are at any given time. If an event such as a war, volcano, earthquake, etc. were to occur, an entity would want to determine if any travelers are impacted, determine whether each traveler is safe, and potentially re-route the traveler based on the changing circumstances on the ground. Entities can rely on reporting systems provided by travel service products to determine the location of each traveler. If travelers do not purchase their services and/or products through the entity's travel system or agency, then the entity may not be able to track the travelers.

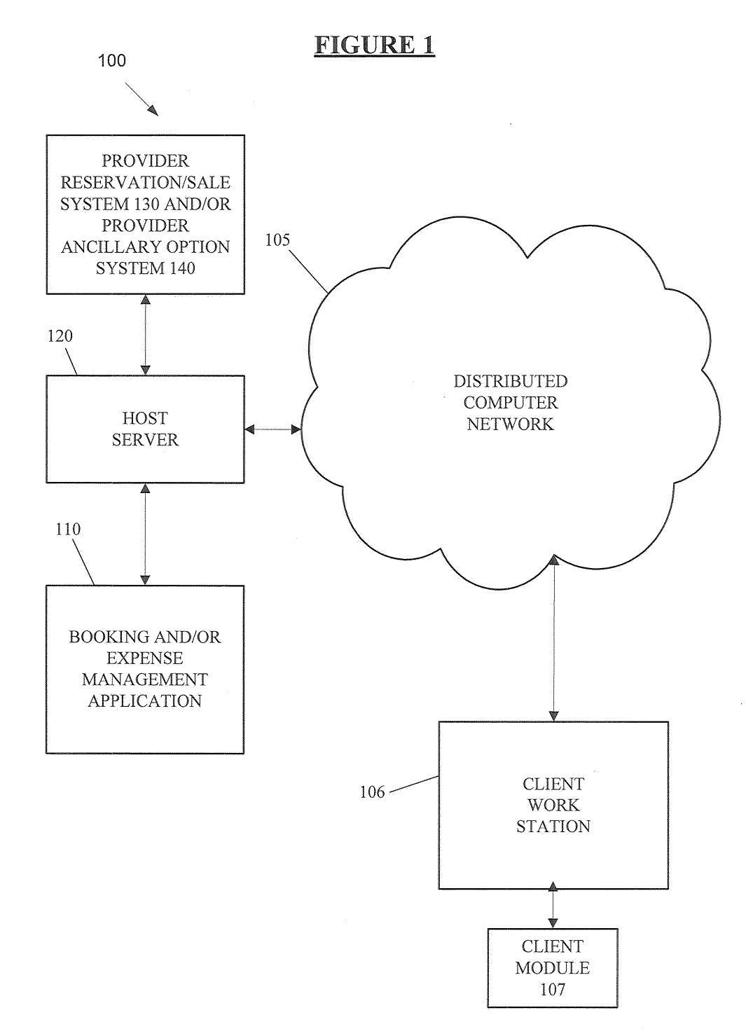

FIG. 1 illustrates a system for ancillary option and fee management, according to one embodiment. In FIG. 1, a computer-implemented system is provided for ancillary option and fee management, which is configured to: receiving travel request data; retrieving primary travel product(s) and/or service option(s) from at least two providers meeting at least some of the criteria of the travel request data; determining an ancillary fee option related to the primary travel product and/or service; and presenting the ancillary fee option with the primary travel product and/or service option. It should be noted that the primary travel product(s) and/or service(s) come from at least two providers. Thus, for example, airfare and related ancillary options and costs can be displayed for two different airlines. In this manner, the true cost of taking each airline can be better determined.

Using the system of FIG. 1, a user can determine which products and/or services meet his criteria, and also determine which ancillary offers are available. Ancillary offers can be presented to the user at the same time, or close to the same time, the primary product and/or service the user is buying is presented. For example, a list of airline ancillary offers can be presented alongside airline fares (e.g., next to the fare display, or as a pop-up window the user can click on). It should be noted that that ancillary offers do net need to have a fee associated with them. For example, a user could be asked to join a frequent flyer program. As another example, different fees can apply to different travelers (e.g., frequent travelers would not be charged for the first bag; non-frequent travelers would be charged for the first bag).

It should be noted that this system could be a traditional web-based application inside a computer browser, a client-server application which runs on a local personal computer, a mobile web application which is optimized for a smart phone or PDA, a system that involves sending email, text or other short messages to a device (e.g., phone computer), or a mobile application that runs as a program on a smart phone, PDA, iPad, or other mobile computing device.

It should also be noted that the system does not require a GDS for purchase of the ancillary options, although it can support them. It can integrate with expense reporting systems and business intelligence systems. The user can see all options at the time of booking and still have the booking go through the preferred corporate channels. The system can also help ensure that fees are not paid for ancillary options until the user has elected to purchase and hold the primary offering (e.g., the ticket).

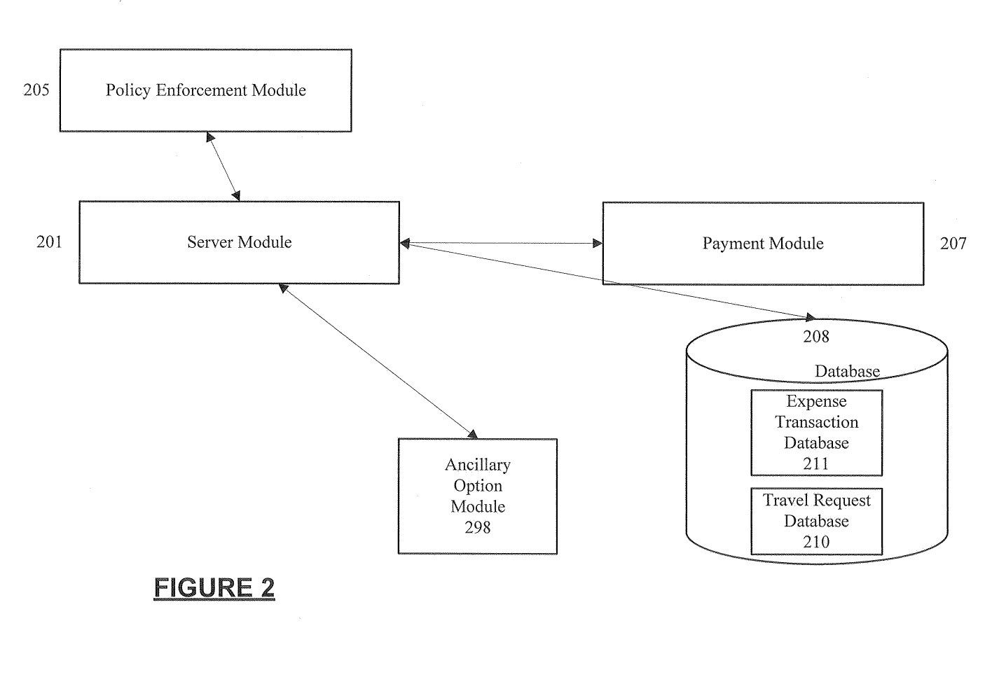

FIG. 1 illustrates some primary components of a representative operating environment, according to an embodiment of the present invention. An on-line environment 100 can comprise: a distributed computer network 105; a client workstation 106; a client module 107; a booking and/or expense management application 110 in communication with a host server 120; a provider reservation and/or sale system 130, or a provider ancillary option system 140, or any combination thereof. It should be noted that many configurations are possible. For example, the booking and/or expense management application 110 can be accessed from the work stations 106, which communicates with the host server 120. In addition, the booking and/or expense management application 110 can be wholly or partially located on the client work station 106. Additionally, the booking and/or expense management application 110 can be wholly or partially located on the host server 120. Those of ordinary skill in the art will see that other configurations are also possible. It should be noted that any of the modules, applications, systems, etc. of FIG. 1 or 2 can be optional.

Referring back to FIG. 1, the distributed computer network 105 can be a network (e.g., Internet, Intranet) that facilitates communication between one or more workstations 106, such as personal computers (PCs), minicomputers, microcomputers, main frame computers, telephone devices, or other wired or wireless devices, such as hand-held devices. FIG. 1 also illustrates a booking and/or expense management application 110, which is housed, for example, on a host server 120, which includes, for example, a minicomputer, a microcomputer, a PC, a mainframe computer, or other device with a processor and repository (e.g., database) or coupling to a repository.

The workstation 106 can accept input from users, and allow users to view output from the reporting application. The client module 107 can include software on the workstation 106 that let a user view, for example, HyperText Markup Language (HTML) documents and access files and software related to those documents. The present invention can utilize, for example, HTML-based systems, Java-based systems, XML-based systems and systems where a custom-built application communicates over the network. Those of ordinary skill in the art will see that many other types of systems can be utilized.

The booking and/or expense management application 110 can work on or with a client module 107 to display information to the user so that services and/or products can be booked and/or expensed. The details of the booking and/or expense management application 110 are set out in FIG. 2. The booking and/or expense management application 110 can work with many other types of tools (e.g., global distribution system, service provider website (e.g., airline website, car rental website), or internal database, or any combination thereof) to determine which offers are available that correspond with the primary service and/or product the user is interested in buying.

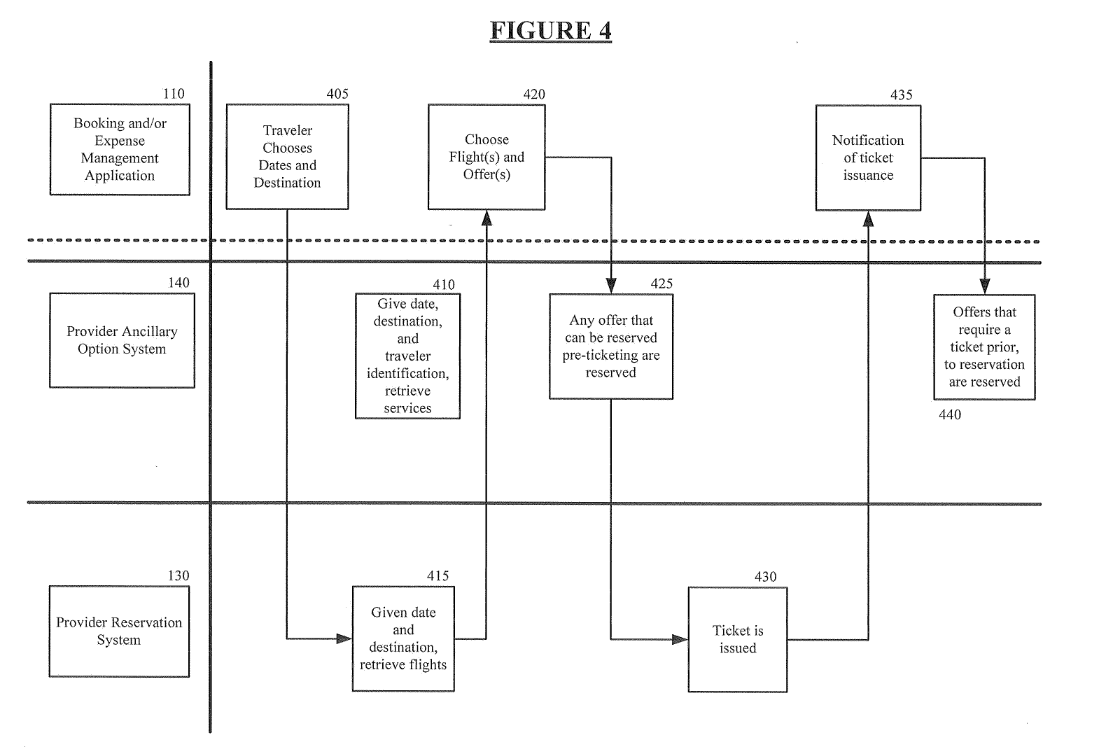

The booking and/or expense management application 110 can be utilized with and/or can access information in a provider reservation and/or sale system 130 and/or a provider ancillary option system 140, as described below with respect to FIG. 4.

FIG. 2 is a system diagram illustrating booking and/or expense management application 110 of FIG. 1, according to one embodiment of the present invention. The booking and/or expense management application 110 can comprise a server module 201, a policy enforcement module 205, a reporting module 206, a payment module 207, a database 208, and an ancillary option module 298. While these various modules are explained with respect to the booking and/or expense management application 110, those of ordinary skill in the art will see that not all modules described are necessary. In addition, additional modules or combination modules are possible. Additionally, it should be noted that pieces of modules can be utilized with or without other modules.

In one embodiment, the booking and/or expense management application 110 can include a server module 201, which can communicate with a client module 107 (e.g., on a client work station 106) through the network 105. A user (e.g., traveler, traveler's assistant) can use the client module 107 to book a product and/or service (e.g., plane ticket, car rental, hotel room) as well as ancillary offerings (e.g., seat upgrade, luggage, GPS). When booking a product and/or service and/or ancillary offerings, the user can access a provider reservation and/or sale system 130 or a provider ancillary option system 140, or both. (Note that in some embodiments, the provider reservation and/or sale system 130 and the provider ancillary option system 140 can be in one system or split up between numerous systems. In one embodiment, the client module 107 can communicate with the server module 201 so that a user can book a primary service and/or product, book any ancillary services and/or products, submit expense reports, or download travel data or credit card data. The server module 201 can transmit data to the client module 107 (e.g., corporate policy data, data accumulated from various travel and expense data sources). Additional details on submitting expense repots, downloading travel data, or other credit card data can be found in the patent applications which are incorporated by reference. The booking and/or expense management application 110 can contain any number of modules that receive, process, or send (or any combination thereof) expense data.

Those experienced in the art will recognize that many other modules can be used to build the booking and/or expense management application 110. It should also be noted that when the server module 201 transmits travel and expense data to the client module 107 and/or the server module 201 can annotate that data with extra information not received from the original data sources. For example, the server module 201 may determine or receive an indication that charges from a certain vendor are of a certain type based on either domain information (e.g., charges from “Hilton” are typically hotel room charges) or information gleaned from previous uses of the system (e.g., a particular traveler has previously submitted charges from “Macaroni Grill” that were meals, so future charges from “Macaroni Grill” will likely be for meals).

Data found and utilized by the booking and/or expense management application 110 can be stored in database 208. In one embodiment, the database 208 can comprise a travel request database 210 and an expense database 211. The system 100 can use the databases 208, 210, and 211 to track information related to ancillary options.

The travel request database 210 can comprise data received by using some combination of multiple sources (e.g., an on-line booking tool, a travel agent, contact with a travel vendor, the provider reservation and/or sale system 130, the provider ancillary option system 140). The travel request data from these sources can be assembled and stored in the travel request database 210, typically as a Passenger Name Record (PNR).

The expense transaction database 211 can comprise expense data received from multiple sources as well. The payer (e.g., the user, the traveler, the traveler's assistant), can pay the travel agency or travel vendor with, for example, a credit card. The record of this transaction can go to the credit card vendor, which can transmit funds to the travel vendor for the amount purchased. The expense transaction database 211 could be used in the following example: after travel occurs, and a user goes to submit an expense report, information about offers can be retrieved from, for example, the expense transaction database 211 because all information on offers can be saved to this or another database. When there is a refund or a canceled trip, the ancillary option module 298 can help determine what offers should be canceled and help direct cancellation of those offers. It should be noted that in some embodiments, a report database can also be utilized. The report database can help with the above type of situation, and can also store reports related to ancillary fees so that this information can be accessed.

The booking and/or expense management application 110 can receive travel data from a travel system, expense transaction data from a credit card vendor, and purchasing data from a travel vendor. For a given expense, data may be present from any number of sources, including the possibility that no data is present. The booking and/or expense management application 110 can receive data from the multiple sources at different times and different rates. A source could transmit data continuously or near-continuously (e.g., once per hour), daily, weekly, or even monthly or at longer intervals. The booking and/or expense management application 110 can store all the data received from all the sources when the information is received. The booking and/or expense management application 110 can identify the traveler corresponding to a given travel request or expense data. Expense data can come encoded with a credit card number that has been assigned to a specific person. For example, for central billed cards, other traveler-identifying information can be included. In an alternate embodiment, if a user uses an on-line self-booking tool to make a travel request, an identification of the user making the request (or user on whose behalf the request is made) can be stored at the time of request, and the record locator from the PNR can also be stored. Travel data identified by this specific record locator can be mapped to a specific traveler. Information about a traveler can be embedded into the remarks section of the PNR by the travel agency, or the passenger's name can be read from the PNR. Similar methods can be used to identify the traveler on data transmitted directly from a travel vendor. Additionally other uniquely identifying information, such as frequent traveler numbers, can be used.

The booking and/or expense management application 110 can also include a policy enforcement module 205 and a payment module 207, or any combination thereof. The policy enforcement module 205 can review, for example, various ancillary options, to make sure they comply with company policy before displaying any ancillary options to a user. The policy enforcement module 205 can also order ancillary options in a particular order based on company policies. The payment module 207 can receive payment information that can be used to pay a provider's system or some other system. In addition, the payment module 207 can send information t the expense transaction database 211 regarding what has been purchased.

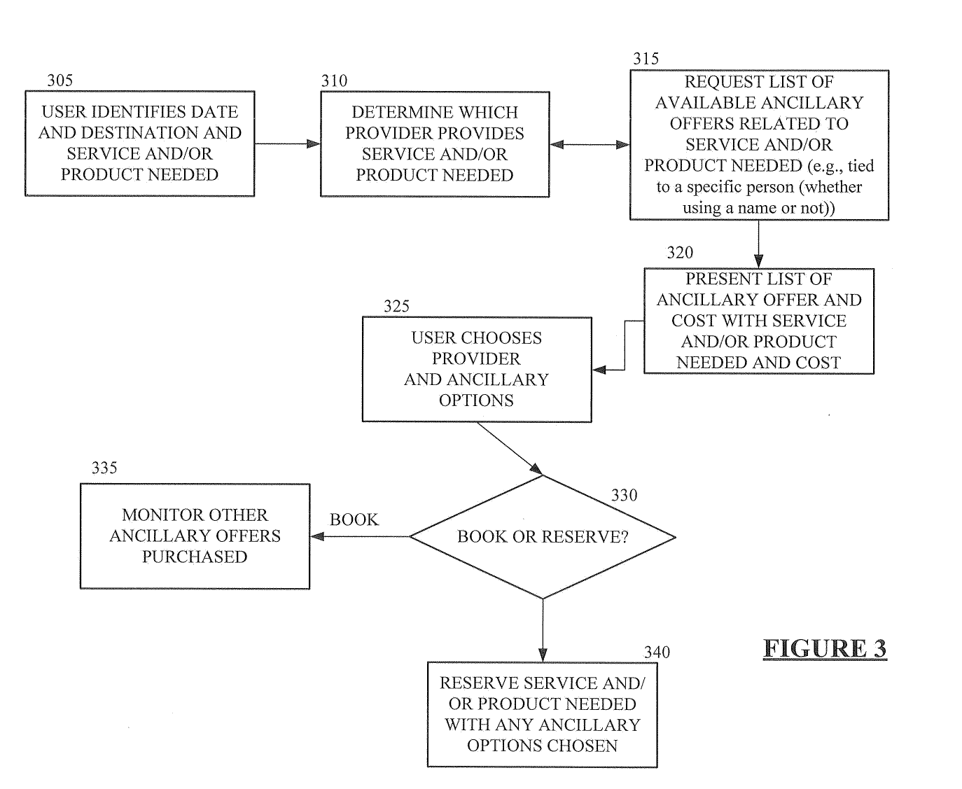

FIG. 3 presents a flowchart illustrating a method for ancillary offer and fee management, according to one embodiment of the present invention. In 301, the user can identify a date, a destination, and a service needed (e.g., air, hotel, car). For example, a user could indicate that he would like to buy an airline ticket for a flight on October 10-13 from Washington D.C. to Seattle. Those of ordinary skill in the art will see that the user can enter and narrow this search in many ways (e.g., search only one airport, search multiple surrounding airports, search for non-stop flights). In 310, the booking and/or expense management application 110 can determine which provider(s) provides the service needed by the user. For example, the booking and/or expense management application 110 can determine that UNITED and DELTA have non-stop flights from LAD to SEA. In 315, the ancillary option module 298 can request a list of available ancillary offers related to the primary product and/or service needed by the user. This information can be requested from multiple sources. For example, any information in the database 208 related to previous travel for this user or other users could be reviewed for ancillary option information (e.g., from the travel request database 210 and/or from the expense transaction database 211). The database 208 could also contain a current list (e.g., which could be constantly updated) of known ancillary options for each provider. In additional embodiments, a provider's ancillary option system 140 (which could be part of a provider's reservation and/or sale system 130) and/or a GDS could also be utilized to determine what ancillary offers are available. In other embodiment, any of these systems, or any other system from a provider could be used to provide ancillary options to the booking and/or expense management application 110. Thus, in some embodiment, some or all of the information above can be accessed, as well as other information sources that become available. In this way, the provider could provide very up-to-date information that is tied to a specific person (whether or not an actual name is tied to a person) and/or to a specific entity (whether or not an actual name of the entity is provided) so a provider can market directly to a specific person and/or entity. (This is sometimes referred to as authenticated shopping.) For example, the following ancillary offers could be found to relate to the UNITED flight: upgrade class, upgrade seat, baggage, food, Internet. The following ancillary offers could be found to relate to the DELTA flight: upgrade class, movie, baggage, food. The ancillary offer can be directly marketed towards the traveler by the booking and/or expense application 110 providing frequent flier information, a name, or other identifying information (e.g., where the traveler travels and when, where the traveler eats) that the provider can use to market to this particular traveler. It should be noted that in some embodiments, information about a person can be provided without actually providing the person's name. This can be helpful in embodiments where the particular identity of a person does not need to be known in order for the provider to provide the product or service (e.g., when the provider is a restaurant, grocery store, gas station, etc.), it should also be noted that, in some embodiments, some airlines may prefer to present a single price that includes the air ticket and a package of one or more ancillary goods or services. For example, where a United Airlines ticket may ordinarily cost $399, a checked bag $25, and a premium seat $30, United may elect to present a single package price of $439 which would include all three. The total price of the package may vary by individual traveler as the airline may wish to give certain travelers (e.g., frequent fliers, employees of certain companies, executives) special prices. In this circumstance, the ticket could be issued through the GDS, while the amount for the package is purchased through a direct connection with the airline, or vice-versa, or the entire package could be purchased through one source.

In 320, the cost for the primary service and/or product and the cost for each of the ancillary offers can be presented to the user, so the user can make an informed choice on which is the best overall value for the user and which package of ancillary offers is most interesting to the user. This ancillary information can be presented at the same time or near the same time as the reservation or sale opportunity for the primary service and/or product. For example, the ancillary options available can be presented next to or underneath the primary offering. In other embodiments, the ancillary options available can be presented as a pop-up by the primary offering. Those of ordinary skill will see that there are multiple ways to present this information in a manner that is convenient to the user.

In 325, the user chooses the primary service and/or product and the ancillary offers that the user wishes to buy or reserve at this point in time. For example, the user could choose the UNITED flight and pay to upgrade the seat to more legroom. A provider's ancillary option system 140 (which could be part of a provider's reservation and/or sale system 130) and/or a GDS could be utilized for the buying and/or reserving. In some embodiments, if a GDS were used to purchase the ticket, and the provider's reservation and/or sale system were used for purchasing the ancillary option(s), or vice-versa, then the ticket number issued from the system issuing the ticket would need to be passed to the system used to purchase the ancillary option(s). This could help ensure that the ancillary option(s) were assigned to the correct ticket purchase, and mitigate a risk that the airline would issue a debit memo (e.g., an industry term for a fee that is levied by an airline when a travel agency improperly handles the purchase of an airline ticket). In additional embodiments, the system used to purchase the ancillary option(s) could return a designator or other identifier that could in turn be passed to the system where the ticket was purchased. This could serve a similar purpose of making sure that the ticketing system were aware of the ancillary option(s) purchased. In other embodiments, both of these methods could be used to maintain a system with even higher levels of redundancy.

In 330, it is determined whether the user bought or reserved the primary service and/or product and any ancillary options. (If the user does not wish to book or reserve anything at this point in time, the user can exit the system. In some embodiments, the system can save the search.) If the user determines to reserve the primary service and/or product and any ancillary options, the booking and/or expense management application 110 can save the information for what was reserved in database 208. It should be noted that not all ancillary options can be purchased prior to the purchase (e.g., a ticket being issued). For example, an airline may allow prepayment for the fee for a checked bag at any time, but require a ticket to be issued before a premium seat can be reserved. Thus, in some cases, a reservation for an ancillary option must be done asynchronously with the reservation for the primary travel product and/or service. In this case, the booking and/or expense management application 110 can monitor the provider reservation system 130 and/or the provider ancillary option system 140 to determine when the primary product and/or service and/or any ancillary options have been bought. In some embodiments, this can occur when the provider reservation system 130 and/or the provider ancillary option system 140 affirmatively sends a notification of ticket issuance. In other embodiments, this can occur when the ancillary option module 298 periodically polls various sources (e.g., provider reservation system 130, provider ancillary option system 140) determine what has been bought. Once the booking and/or expense management application 110 is aware that a reservation for a primary travel product and/or service option is accepted (e.g., booked), the ancillary option module 298 can then attempt to accept (e.g., book) any ancillary options reserved by the user. In this way, any ancillary options unavailable after the primary travel product and/or service option is accepted can be tracked. The user can then be notified of the success or failure of the purchase of the reserved ancillary options. If the purchase of the reserved ancillary options fails because that ancillary option is now unavailable, then the traveler can be notified of other alternate available ancillary options. For example, if a particular seat was offered (e.g., an airline seat upgrade for additional compensation; a particular seat reserved for frequent fliers) but could only be reserved post ticketing, if the offer is no longer available when the airline ticket is issued, such as a seat selection, the traveler could be sent a notification for an alternate seat. Thus, if a user reserves seat 2C (an aisle seat as the front of the plane) at the time of reservation, and post-ticketing, that seat is taken, a notification could be sent saying that seat 2D (also an aisle seat at the front of the plane) is also available and to respond affirmatively if the user would like the seat. It should be noted that these notifications can take place by email, phone texts, a web page presented in a web browser, or any other technology available and known to those of ordinary skill in the art. It should also be noted that, in some embodiments, the purchase for the primary product and/or service can be made dependent on the reserved ancillary options being available. It should also be noted that, in some embodiments, multiple notifications can be sent indicating certain ancillary options are currently available. These multiple notifications can ping the user at certain key points in time.

When a user goes to create an expense report, the information related to primary and/or ancillary products purchased can be retrieved from the expense transaction database 211 or from other information stored in database 208. This information can be helpful in making sure all information related to the primary service and/or product is captured. This can be useful in, for example, ensuring all expenses are captured, or making sure company policies are adhered to, or making sure all fees are refunded when appropriate, or any combination thereof. The ancillary option module 298 can also use various methods (e.g., such as those set forth in the patent applications incorporated by reference) to determine if there were any services purchased outside the system, such as through a check-in kiosk or bought on board the aircraft, and properly include those ancillary fees.

FIG. 4 is a flowchart illustrating an example method for ancillary option and fee management, according to an embodiment of the present invention. The chart outlines the communications between a booking and/or expense management application 110, a provider ancillary option system 140, and a provider reservation and/or sale system 130. In 405, the booking and/or expense management application 110 can receive a request for a traveler, which can include date(s) and destination(s) to which the traveler wishes to travel. In 410, the booking and/or expense management application 110 can then provide a provider ancillary option system 140 with the dates and destinations and any available identifying information (e.g. name, frequent flyer number, or affinity program number, or any combination thereof) for the traveler. In 415, the booking and/or expense management application 110 can also provide the dates and destinations to a provider reservation and/or sale system 130. The provider ancillary option system 140 and the provider reservation and/or sale system 130 can return the ancillary services information and the flight availability information respectively back to the booking and/or expense management application 110, which can display the information to a user who can choose primary products and/or services (e.g., flights, cars, hotel rooms) and ancillary offers in 420. The provider can also return the traveler's status in the provider's affinity program (e.g., a traveler may be an AAdvantage Platinum member with American Airlines, or a Premier Executive on United Airlines, but only a general member of the Delta Airlines program). The booking and/or expense management application can use information about program status to tailor content or ancillary offer information to frequent or premium travelers. Any ancillary offers that can be purchased prior to ticketing can be purchased by having the booking and/or expense management application 110 access the provider ancillary option system 140 in 425. In 430, the purchase for the primary product and/or service can be completed. In 435, a designated user (e.g., traveler, traveler's assistant) can receive notification that the purchase was completed. In 440, this can trigger purchase of any ancillary offers that require ticketing.

It should be noted that the booking and/or expense application 110 could be a GDS, a direct connection to an airline reservation system, or some alternate system, or any combination thereof. The notification in 435 could be an active notification, such as where the provider reservation and/or sale system 130 affirmatively sends a message to the booking and/or expense management application 110 that a ticket has been issued, or it could be a passive notification, where the booking and/or expense management application 110 is responsible for polling or otherwise monitoring the provider reservation and/or sale system 130 to detect the ticket issuance.

It should be noted that travel vendors can be continually evolving and enhancing the list of ancillary goods and services being offered, and this list of ancillary goods is not limited by the goods and services offered today (such as baggage fees, preferential boarding, or preferential seating).

It should also be noted that in some embodiments, a travel agency or an agent of the travel agency may charge the traveler for the service of making the reservation, or for another ancillary good or service provided by the agency.

In addition, it should be noted that, after paying for one or more of the travel events and one or more of the ancillary goods or services, the traveler can submit an expense report. Expense reports can serve multiple purposes, including, but not limited to: allowing the employee to be reimbursed for approved out-of-pocket expenses incurred during business travel, allowing the company to track the consumption of travel event requests that were previously reserved in order to estimate expenses that will be submitted in the future; or allowing the company to track travel event requests not reserved through the corporate travel management system; or any combination thereof. Companies often have contracts with specific travel vendors and/or agencies, and these contracts often have minimum purchase requirements that must be met in order for the company to receive the preferred rates specified in the contracts. Thus, it can be helpful to be able to track all amounts that are spent at a certain vendor.

It should also be noted that expenses incurred by the traveler while traveling at the request of his employer are generally reimbursed by the corporation. Companies have travelers complete expense reports that itemize the expenses, and have the expense reports approved by managers and/or employees in the accounting department. Systems that automate some or all of the expense reporting process can accept data feeds from corporate credit card vendors (e.g. Visa, American Express, MasterCard) and allow the travelers to import the credit card charges to reduce manual data entry and improve accuracy. Expense management systems can also be integrated with travel agency systems, or GDS (e.g., Apollo, Sabre, or Amadeus), to obtain, for example, travel itinerary data. The travel itinerary data can be matched with credit card data (using, for example, vendor information, amounts, dates of travel, etc.). Companies can then run reports on their travel and expense data to look at the total spent by type of transaction (e.g. air fare, rental car, meals, entertainment) or the total spent by supplier (e.g. United Airlines vs. American Airlines). More sophisticated systems can compare the amounts requested for reimbursement against the amount of a reservation to see if the actual cost differed from the initially requested cost, analyze the vendor spend for specific geographic regions or airline city pairs, and import receipts directly from vendors in order to have a third source for matching against the travel itinerary and credit card data.

It should also be noted that travel managers can use the reservation and expense data when negotiating with entities, such as airlines. For example, if a travel manager knows that her company is spending $1 million per year flying travelers from Washington, D.C. to Los Angeles, Calif., and that the amount is evenly split between two competing airlines, that travel manager could approach the airlines and offer to shift business from one to the other in exchange for some form of discount. Additionally, travel managers can set policies in systems that enable travelers to make travel reservations and systems that automate the completion of expense reports to indicate that certain expenses would not be reimbursed, or would need extra approval prior to reimbursement. For example, many companies do not reimburse for movies rented during hotel stays, or for airline club memberships (e.g. United Airlines Red Carpet Club) except under certain circumstances such as trips over a certain number of days or trips over a certain distance, or for certain very frequent travelers.

In the above situations, as well as in many other situations, ancillary fees can pose a challenge. For example, some ancillary fees can be charged at the time of the main purchase (e.g., at the time a ticket is purchased), while other ancillary fees are charged a check-in process or on-board. A traveler may not know at time of ticket purchase that a bag would be checked, or that the traveler would want a pillow on board. These ancillary fees can thus be charged to the traveler (e.g., via credit card) at a different time than the airline ticket itself. Thus, an entity would not always know what is being spent on these ancillary fees as opposed to, for example, the air fares themselves.

In one embodiment, a system and method are provided that can properly categorize ancillary fees as such, and can identify the specific reservation that corresponded to the main purchase (e.g., flight taken with airline ticket) on which the fee was incurred. In one embodiment, the system can enforce entity policies on these additional services. In one embodiment, reports can be provided that hold employees responsible for travel and accounting information about the spend, including the amount of spend by travel supplier and even the amount of spend in specific geographies, on certain routes, and/or by specific travelers or departments. This data can help the company negotiate these ancillary services as part of a contract with a specific travel vendor in lieu of or in addition to a specific rate on the base service. For example, a travel manager might prefer to negotiate free checked baggage instead of a 2% discount on the air fare, if it could be determined that the company was spending more than 2% of their air-related spend on checked baggage.

In one embodiment, the booking and/or expense management application 110 can analyze the expenses submitted across one or multiple companies to identify changes in fees for ancillary goods or services, or identify new fees implemented by a travel vendor. The booking and/or expense management application 110 could then adjust the criteria used to determine whether or not an expense corresponded to an ancillary fee based on the this data. In a further embodiment, the booking and/or expense management application 110 could understand that a vendor may change the fee for a good or service effective a specific date and use the data to determine that effective date, and use that date information when analyzing incoming expenses.

In one embodiment, companies can configure travel policies that prevent the selection, require approval for the selection, or log selection of ancillary services procured at time of reservation that would incur ancillary fees. Travelers electing to purchase these services if they are against policy may be required to choose a reason from a list of possible reasons or provide an explanation of why they are violating the policy. Employees of the company would be able to run reports that identified the fees that were incurred in violation of policy and why the travelers indicated that policy had been violated. Sample policies relating to ancillary fees includes, but are not limited to determining: whether or not a given ancillary fee type is allowed as a business expense; whether or not a given ancillary fee type has exceeded a total amount spent (e.g., the traveler is allowed to spend $300 on airline lounges per year), or whether or not the expense report needs approval and if so by whom (e.g., the traveler needs approval by her boss and the travel manager to buy a seat upgrade).

In one embodiment, companies can also configure policies as part of the expense reporting process, where the policies define whether or not certain types of fees would be reimbursed, if incurring certain amount of ancillary fees require an explanation or approval of the expense report, or if there is a cap on the maximum amount of certain types of fees that may be allowed. Practitioners of the art would understand that many other types of policies that could be configured. The expense reporting system could then enforce the policies, and employees of the company could run reports that analyzed the fees that were submitted for reimbursement and provided breakdowns of in-policy vs. out-of-policy fees.

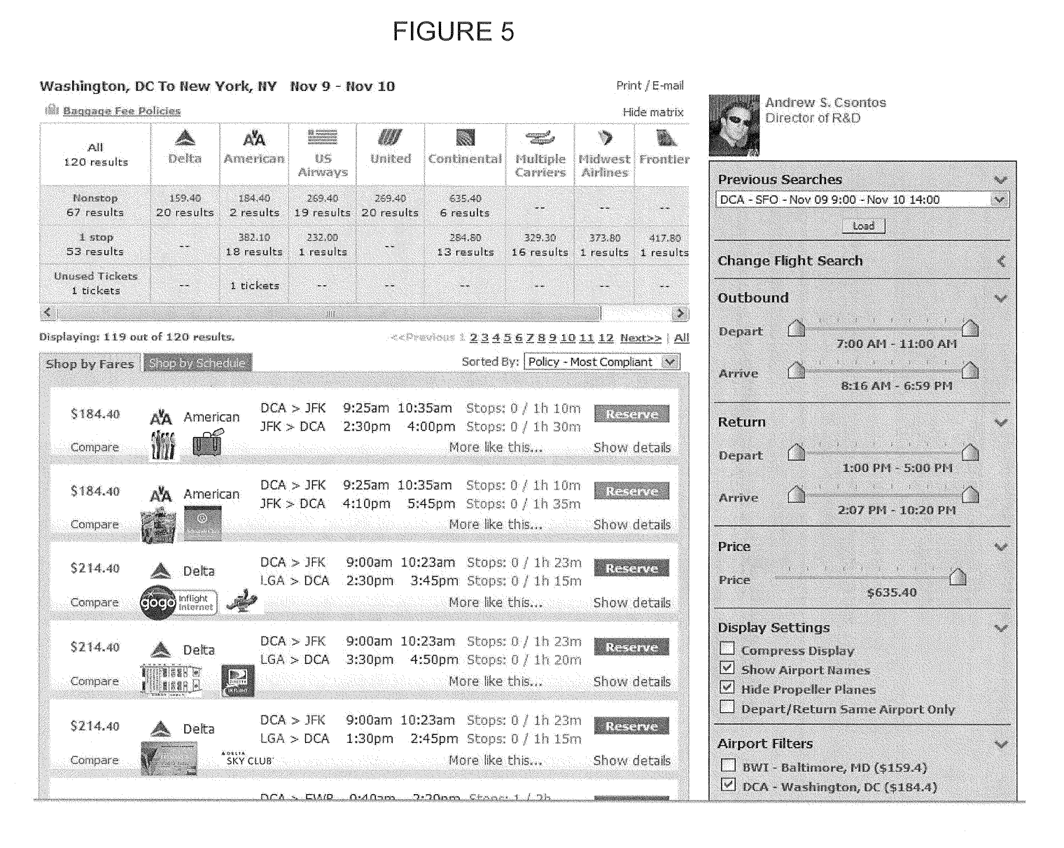

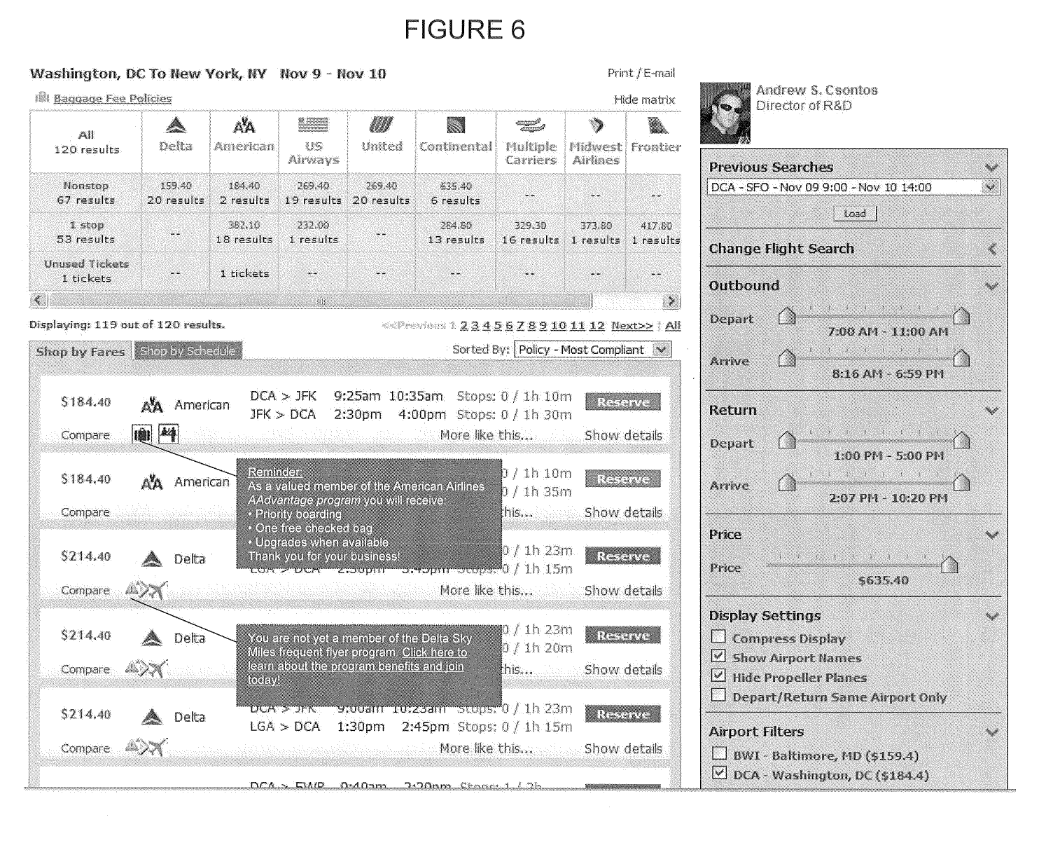

FIGS. 5-7 are example screen shots illustrating a system for ancillary option management, according to various embodiments of the invention. In FIG. 5, several ancillary offers (e.g., flight Internet, American Express card, sky club) are shown using logos that are related to a specific entity (e.g., Delta brand of Internet; Delta sky club logo, Delta credit card logo) displayed next to primary offers (e.g., flights on Delta). These offers are shown in response to a search. Those of ordinary skill in the art will see that this ancillary offer information can be displayed in many ways (e.g., using logos, words) at and/or near the same time that the primary offer information is shown. FIG. 6 illustrates additional logos representing other ancillary offers (e.g., unique fare, early boarding, free checked bag, snack/drink coupon, club pass, business class upgrade, in-flight wifi, preferred coach seating, DIRECTV, double miles, discount change/Tree standby). In the embodiment shown in FIG. 6, standardized icons can be used. In some embodiments, when a user mousse over or otherwise accesses an icon representing an ancillary offer, information on the ancillary offer can be illustrated, as shown in FIG. 6. It should be noted that not all offers are not associated with a cost or other charge (e.g., such as frequent flier points), and that some offers provide only information or can result in the traveler receiving something of value from the provider in response to something the traveler does (e.g., frequent flier points, free ticket, money for taking a later flight).

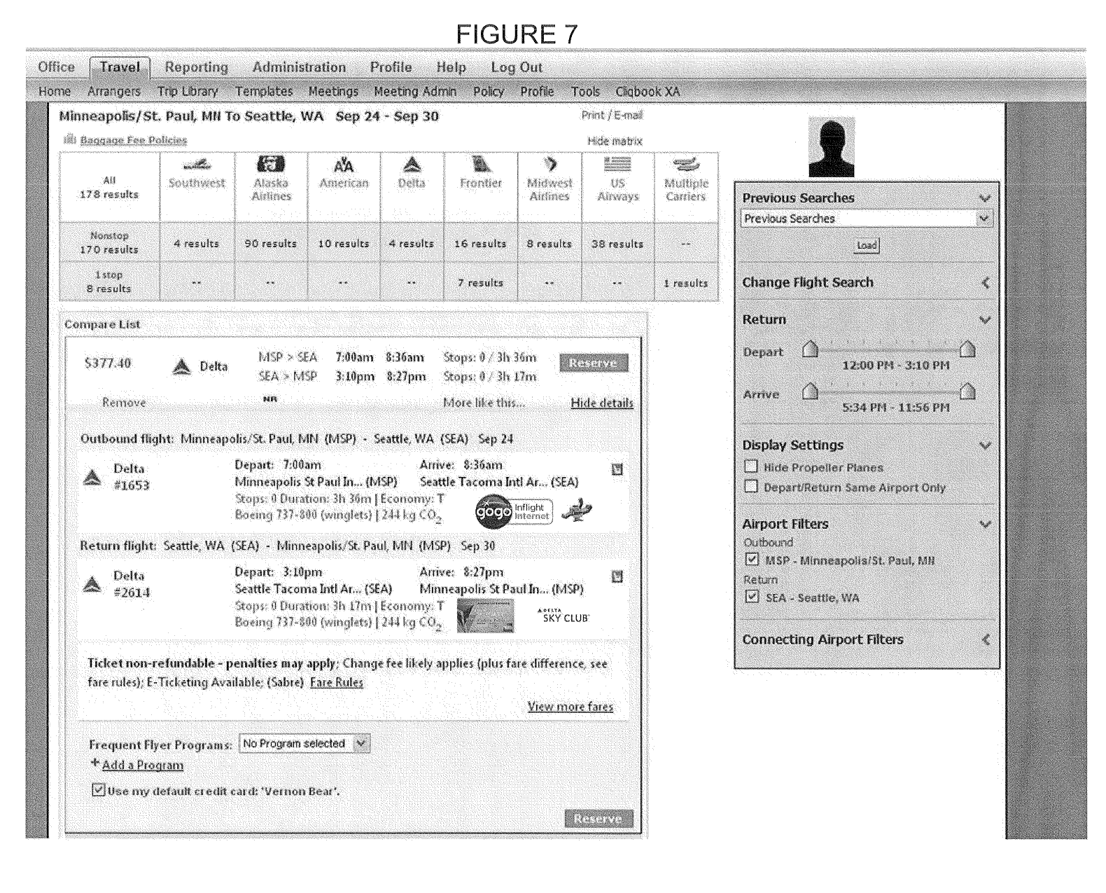

FIG. 7 illustrates an embodiment where, even though standardized icons are shown when various options are presented, when details for a specific flight are shown, the airline-specific logos can be shown at that time. Of course, in some embodiments, the standardized icons could be shown at this point as well. For example, when a user clicks on or mouses over a suitcase logo, information can be displayed reminding the traveler that he is a frequent flier and receives the following for free: priority boarding, one free checked bag, an upgrade when available). This information could entice a traveler to use a particular provider. As another example, when the user clicks on or mouses over another logo, information can be displayed indicating that the traveler is not a member of a frequent flier group, and that he can join this group, if desired.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown. For example, the steps listed in any flowchart may be re-ordered or only optionally used (even when not explicitly indicated) in some embodiments. Thus, those skilled in the art will realize that the ordering of the steps of the figures can be altered in other embodiments and that various steps can be removed in some embodiments.

It should also be noted that when the term “a”, “an”, “the”, “said”, etc. is used, it is to be interpreted as “at least one” or “the at least one” throughout the application and claims.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A computer-implemented method of ancillary travel option management comprising:
receiving, via at least one computer network, by at least one booking and/or expense management application, travel request data for at least one traveler;
retrieving, by the at least one booking and/or expense management application, at least one primary travel product and/or service option, each at least one primary travel product and/or service option from at least two providers meeting at least some of the criteria of the travel request data;
determining, by the at least one booking and/or expense management application, at least one ancillary option and at least one price for the at least one ancillary option related to the at least one primary travel product and/or service; and
presenting the at least one ancillary option and the at least one price for the at least one ancillary option with the at least one primary travel product and/or service option.

2. The method of claim 1, wherein traveler identifying information for the at least one traveler is provided to the at least two providers so that any ancillary options personalized to the at least one traveler can be presented.

3. The method of claim 1, further comprising:
tracking information relating to which of the at least two primary travel product and/or service options are accepted; and tracking information relating to which of the at least one ancillary fee options are accepted.

4. The method of claim 3, wherein the information relating to which of the at least two primary travel product and/or service options are accepted and the information relating to which of the at least one ancillary fee option are accepted are stored in at least one expense report.

5. The method of claim 1, wherein at least one reservation for at least one ancillary option can be done asynchronously with at least one reservation for at least one primary travel product and/or service.

6. The method of claim 5, wherein the at least one ancillary option is accepted after the at least one primary travel product and/or service option is accepted.

7. The method of claim 5, wherein information on any ancillary option unavailable after the at least one primary travel product and/or service option is accepted is tracked.

8. The method of claim 5, wherein at least one alternate ancillary option related to any unavailable ancillary option is presented.

9. The method of claim 3, wherein information relating to which of the at least two primary travel product and/or service options are refunded and information relating to which of the at least one ancillary options are refunded are tracked.

10. The method of claim 3, wherein the entire cost for the primary travel product and/or service with any ancillary fees is tracked.

11. The method of claim 1, wherein the at least one primary travel product and/or service option is for:
air travel;
car rental transportation;
limousine service;
hotel;
train service;
or any combination thereof.

12. The method of claim 1, wherein the at least one ancillary option comprises:
checking baggage;
seat assignment;
frequent traveler miles or points;
access to an airline club or lounge;
use of a pillow or blanket during a flight;
ability to store carry-on baggage in the overhead compartment in an airplane;
or food or beverage;
or any combination thereof.

13. The method of claim 1, wherein at least one entity is able to track:
total amount spent for each type of ancillary good or service;
total amount spent with each travel vendor for each type of ancillary good or service;
or any combination thereof.

14. The method of claim 1, wherein at least one entity is able to track:
total amount spent by geographic region for each type of ancillary good or service;
total amount spent by origination and destination city for each type of ancillary good or service;
or any combination thereof.

15. The method of claim 1 wherein at least one entity is able to configure at least one expense reporting system to have at least one policy that determines the maximum amount that at least one individual traveler may spend on at least one specific type of ancillary good or services, and wherein the at least one expense reporting system may require approval for at least one expense report, or prevent submission of at least one expense report, if a user creates at least one expense report that would be in violation of these policies.

16. The method of claim 1 wherein at least one of the at least two providers returns to the at least one booking and/or expense management application at least one current level of status in the at least one of the at least two provider's at least one affinity program held by the at least one traveler.

17. The method of claim 1, wherein the at least one price is greater than or equal to 0.

18. The method of claim 1, wherein the at least one price is less than 0.

19. The method of claim 1, wherein at least one single price representing at least one cost covering both of the at least one primary travel product and/or service and the at least one ancillary option is presented to the at least one traveler.

20. A computer-implemented system of ancillary travel option management, comprising:
at least one application and at least one processor connected over at least one network, the at least one processor configured for:
receiving travel request data for at least one traveler;
retrieving at least one primary travel product and/or service option, each at least one primary travel product and/or service option from at least two providers meeting at least some of the criteria of the travel request data;
determining at least one ancillary option and at least one price for the at least one ancillary option related to the at least one primary travel product and/or service; and
presenting the at least one ancillary option and the at least one price for the at least one ancillary option with the at least one primary travel product and/or service option.

21. The system of claim 20, wherein traveler identifying information for the at least one traveler is provided to the at least two providers so that any ancillary options personalized to the at least one traveler can be presented.

22. The system of claim 20, wherein the at least one application and the at least one processor are further configured for:
tracking information relating to which of the at least two primary travel product and/or service options are accepted; and
tracking information relating to which of the at least one ancillary fee options are accepted.

23. The system of claim 22, wherein the information relating to which of the at least two primary travel product and/or service options are accepted and the information relating to which of the at least one ancillary fee option are accepted are stored in at least one expense report.

24. The system of claim 20, wherein at least one reservation for at least one ancillary option can be done asynchronously with at least one reservation for at least one primary travel product and/or service.

25. The system of claim 24, wherein the at least one ancillary option is accepted after the at least one primary travel product and/or service option is accepted.

26. The system of claim 24, wherein information on any ancillary option unavailable after the at least one primary travel product and/or service option is accepted is tracked.

27. The system of claim 24, wherein at least one alternate ancillary option related to any unavailable ancillary option is presented.

28. The system of claim 22, wherein information relating to which of the at least two primary travel product and/or service options are refunded and information relating; to which of the at least one ancillary options are refunded are tracked.

29. The system of claim 22, wherein the entire cost for the primary travel product and/or service with any ancillary fees is tracked.

30. The system of claim 20, wherein the at least one primary travel product and/or service option is for:
air travel;
car rental transportation;
limousine service;
hotel;
train service;
or any combination thereof.

31. The system of claim 20, wherein the at least one ancillary option comprises:
checking baggage;
seat assignment;
frequent traveler miles or points;
access to an airline club or lounge;
use of a pillow or blanket during a flight;
ability to store carry-on baggage in the overhead compartment in an airplane;
or food or beverage;
or any combination thereof.

32. The system of claim 20, wherein at least one entity is able to track:
total amount spent for each type of ancillary good or service;
total amount spent with each travel vendor for each type of ancillary good or service;
or any combination thereof.

33. The system of claim 20, wherein at least one entity is able to track:
total amount spent by geographic region for each type of ancillary good or service;
total amount spent by origination and destination city for each type of ancillary good or service;
or any combination thereof.

34. The system of claim 20, wherein at least one entity is able to configure at least one expense reporting system to have at least one policy that determines the maximum amount that at least one individual traveler may spend on at least one specific type of ancillary good or services, and wherein the at least one expense reporting system may require approval for at least one expense report, or prevent submission of at least one expense report, if a user creates at least one expense report that would be in violation of these policies.

35. The system of claim 20, wherein at least one of the at least two providers returns to the at least one booking and/or expense management application at least one current level of status in the at least one of the at least two provider's at least one affinity program held by the at least one traveler.

36. The system of claim 20, wherein the at least one price is greater than or equal to 0.

37. The system of claim 20, wherein the at least one price is less than 0.

38. The system of claim 20, wherein at least one single price representing at least one cost covering both of the at least one primary travel product and/or service and the at least one ancillary option is presented to the at least one traveler.
